(19) United States
(12) Patent Application Publication
(10) Pub. No.: US 2014/0168635 A1
(43) Pub. Date: Jun. 19, 2014

(54) INSPECTION METHOD AND INSPECTION FIXTURE FOR SCRIBING LINES OF WAFER

(71) Applicant: YAYATECH CO., LTD., Hsin-Chu (TW)

(72) Inventors: Sheng-Feng LIN, Hsin-Chu (TW); Chien-Cheng Chen, Hsin-Chu (TW); Kuei-Jung Chen, Hsin-Chu (TW); Li-Chueh Chen, Hsin-Chu (TW); Yi-Chien Chen, Hsin-Chu (TW)

(73) Assignee: YAYATECH CO., LTD., Hsin-Chu (TW)

(21) Appl. No.: 13/750,347

(22) Filed: Jan. 25, 2013

(30) Foreign Application Priority Data
Dec. 14, 2012 (TW) 101147513

(51) Int. Cl. G01N 21/95

(52) U.S. Cl. CPC G01N 21/9501
USPC 356/51; 356/237.5

(57) ABSTRACT

An inspection method and an inspection fixture for the scribing lines of a wafer are disclosed. The inspection method includes the following steps: providing a wafer having multiple chips and a lower surface attached with a dicing tape, wherein scribing lines are formed between the chips; connecting the dicing tape with a transparent carrier supporting a first liquid medium such that the dicing tape is contacted seamlessly with the first liquid medium, wherein the difference of refractive index between the first liquid medium and the dicing tape is less than 0.3; and inspecting the scribing lines through the transparent carrier from below the lower surface of the wafer by an inspection lens of an optical inspector. The inspection method and fixture increase the image resolution of the scribing lines so as to facilitate the detection of lower-surface defects of the scribing lines.

### BACKGROUND OF THE INVENTION

1. Technical Field

The present invention relates to an inspection method and an inspection fixture for a wafer and, more particularly, to an inspection method and an inspection fixture for the scribing lines of a wafer.

2. Description of Related Art

FIG. 1 schematically shows a wafer to be inspected. As shown in FIG. 1, an integrated circuit packaging process typically includes a wafer dicing step in which a fully processed to-be-inspected wafer 10 is diced after a dicing tape 20 is attached to its backside.

If a die 11 on the to-be-inspected wafer 10 is damaged during the wafer dicing step without being detected immediately and is used in subsequent steps, the resulting product will be defective. Hence, a bad die 11 which escapes detection will cause a considerable waste of time and materials in the steps that follow. If the to-be-inspected wafer 10 is inspected after the wafer dicing step, the damaged die 11 can be found at an earlier time and be prevented from going through the remainder of the manufacturing process.

FIG. 2 is a sectional view of a scribing line. Generally speaking, as shown in FIG. 1 and FIG. 2, the part of a die 11 that is mostly easily damaged by the wafer dicing step is in the vicinity of a scribing line 12, and the scribing line affected will end up having an uneven surface. Damage caused to an upper part of a lateral side of a die 11 in the vicinity of a scribing line 12 is generally known as an upper-surface defect 111, and damage caused to a lower part of a lateral side of a die 11 in the vicinity of a scribing line 12, as a lower-surface defect 112. While it is as important to detect lower-surface defects 112 of a scribing line 12 as to detect upper-surface defects 111 of the scribing line 12, the detection of lower-surface defects 112 is seriously hindered by the dicing tape 20 beneath the wafer 10.

FIG. 3 schematically shows a conventional way to detect lower-surface defects. As shown in area A of FIG. 3, light always propagates along paths extending in the directions of scattered energy distribution. When detecting lower-surface defects 112, an accurate lower-surface image can be obtained only if the inspection light travels long an ideal image optical path L. However, as the surface of the dicing tape 20 is not an ideal, smooth optical surface, the polarizability of the surface interface of the dicing tape 20 in response to light alters polarized scattered energy distribution on the medium surface. As a result, the scattering of light changes the directions of light energy distribution at the refracting interface, and the light is distributed along the optical path L′ instead. The inspection image thus obtained will be distorted and cannot be used to determine whether lower-surface defects 112 exist. It is, therefore, highly desirable that a method and apparatus for inspecting the scribing lines of a wafer can detect lower-surface defects 112 with clarity.

### BRIEF SUMMARY OF THE INVENTION

The present invention discloses an inspection method and an inspection fixture for the scribing lines of a wafer, wherein the inspection method includes the steps of: providing a to-be-inspected wafer, connecting with a transparent carrier, and inspecting the scribing lines. The present invention increases the image resolution of the scribing lines, making it easy to detect lower-surface defects of the scribing lines.

The present invention provides an inspection method for scribing lines of a wafer, comprising the steps of: providing a to-be-inspected wafer, wherein the to-be-inspected wafer has a plurality of dies, a scribing line formed between each two adjacent said dies, and a lower surface attached with a dicing tape; connecting the dicing tape with a transparent carrier supporting a first liquid medium, wherein the dicing tape is placed on the transparent carrier and is contacted seamlessly with the first liquid medium, and a difference of refractive index between the first liquid medium and the dicing tape is less than 0.3; and inspecting the scribing lines, wherein an inspection lens of an optical inspector is aimed at each said scribing line through the transparent carrier from below the lower surface to inspect the scribing lines.

The present invention also provides an inspection fixture for scribing lines of a wafer, comprising: a dicing tape attached to a lower surface of a to-be-inspected wafer; and a transparent carrier for supporting a first liquid medium and allowing the first liquid medium to contact seamlessly with the dicing tape, wherein a difference of refractive index between the first liquid medium and the dicing tape is less than 0.3.

Implementation of the present invention at least produces the following advantageous effects:

1. The image resolution of the scribing lines of a wafer can be increased to facilitate the detection of lower-surface defects of the scribing lines.

2. As inspection of the scribing lines of a wafer is improved with easily accessible and inexpensive materials, inspection costs can be lowered.

The detailed features and advantages of the present invention will be described in detail with reference to the preferred embodiment so as to enable persons skilled in the art to gain insight into the technical disclosure of the present invention, implement the present invention accordingly, and readily understand the objectives and advantages of the present invention by perusal of the contents disclosed in the specification, the claims, and the accompanying drawings.

### BRIEF DESCRIPTION OF THE SEVERAL VIEWS OF THE DRAWINGS

The present invention will be best understood by referring to the following detailed description of some illustrative embodiments in conjunction with the accompanying drawings, in which:

FIG. 1 is a schematic drawing of a wafer to be inspected;

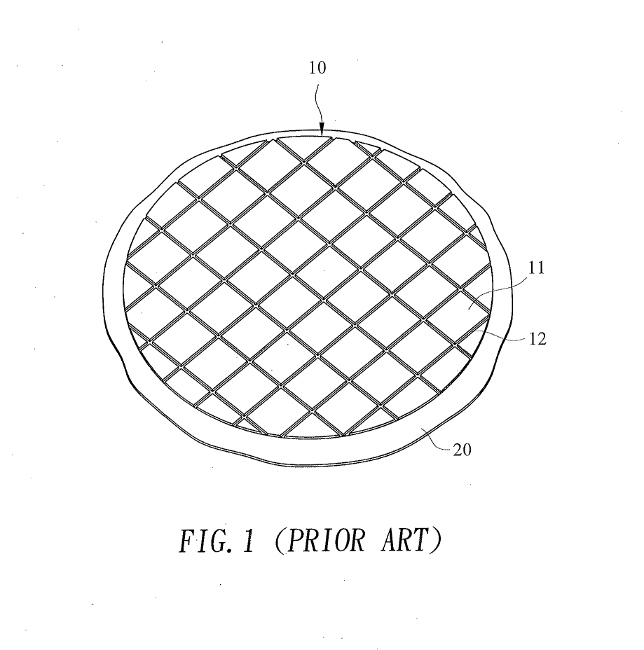

FIG. 2 is a sectional view of a scribing line;

FIG. 3 schematically shows a conventional way to detect lower-surface defects;

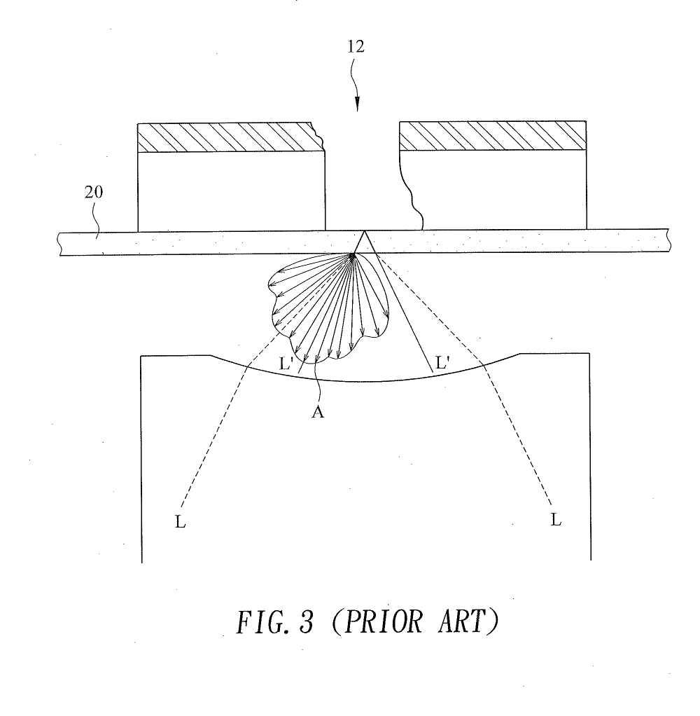

FIG. 4 is the flowchart of an inspection method for the scribing lines of a wafer according to an embodiment of the present invention;

FIG. 5 is a sectional view of a to-be-inspected wafer according to an embodiment of the present invention;

FIG. 6 schematically shows how inspection is carried out according to an embodiment of the present invention;

FIG. 7 schematically shows how inspection is carried out according to another embodiment of the present invention;

FIG. 8 is a sectional view of an inspection fixture according to an embodiment of the present invention; and

FIG. 9 is a sectional view of an inspection fixture according to another embodiment of the present invention;

### DETAILED DESCRIPTION OF THE INVENTION

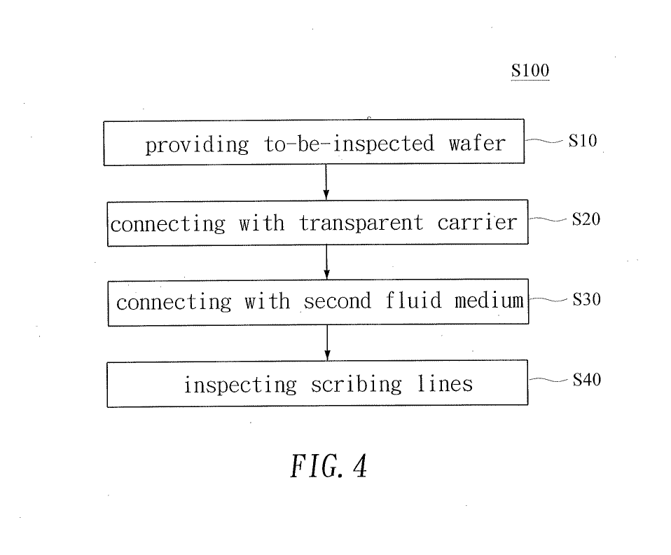

In one embodiment of the present invention, referring to FIG. 4, an inspection method S100 for the scribing lines of a wafer includes the steps of: providing a to-be-inspected wafer (step S10), connecting with a transparent carrier (step S20), and inspecting the scribing lines (step S40).

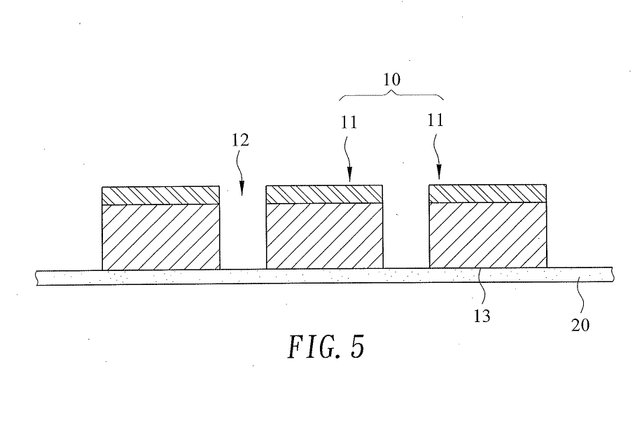

The step of providing a to-be-inspected wafer (step S10) is now described with reference to FIG. 5. A to-be-inspected wafer 10 having a plurality of dies 11 is provided, wherein a scribing line 12 is formed between each two adjacent dies 11. In order to fix the to-be-inspected wafer 10 when the wafer is being diced, a dicing tape 20 is attached to a lower surface 13 of the to-be-inspected wafer 10, allowing the dies 11, once cut off, to remain on the dicing tape 20 in an array arrangement. The dicing tape 20 may be a Blue Tape.

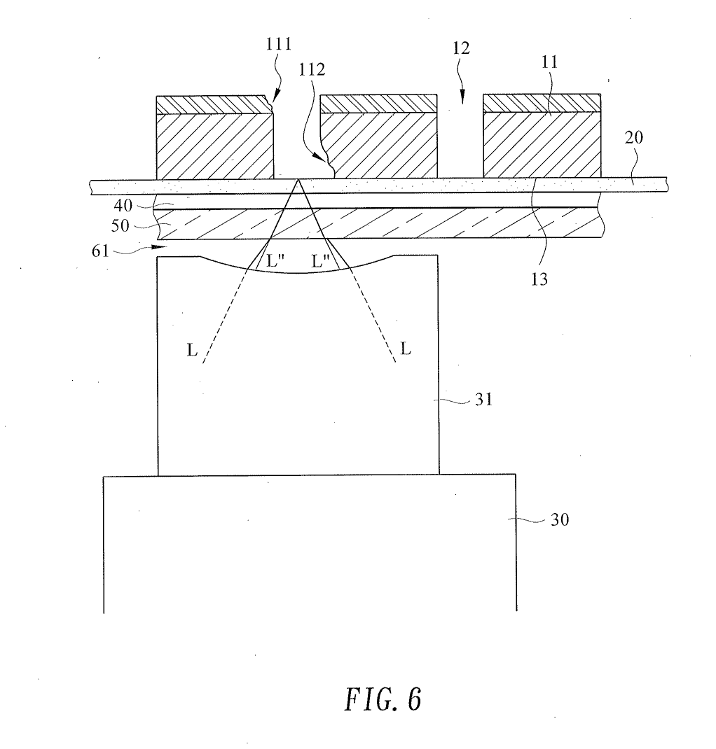

The step of connecting with a transparent carrier (step S20) is detailed as follows. Referring to FIG. 6, a transparent carrier 50 supports a first liquid medium 40. When the dicing tape 20 is placed on the transparent carrier 50 supporting the first liquid medium 40, the surface adhesion force of the first liquid medium 40 results in a seamless contact between the dicing tape 20 and the first liquid medium 40.

If the transparent carrier 50 and the first liquid medium 40 are non-existent, an inspection light reflected by the lower-surface defect 112 will impinge directly on the interface of dicing tape 20 and air medium 61 and direct to an air medium 61. As the polarizability of the dicing tape 20 in response to light affects polarized scattered energy distribution on the interface between the medium surfaces, the reflection light from the lower-surface defect 112 refracted by the dicing tape 20 will be scattered and hence shifted away from the ideal image optical path L, and this causes distortion of the inspection image. If the relative refractive index of the medium interface can be changed to weaken polarized scattering by the medium surface of the dicing tape 20, the polarized scattered energy distribution can be adjusted so that the light which may otherwise be moved away from the ideal image optical path L as a result of scattering is brought close to the ideal image optical path L, thereby improving the resolution of the inspection image.

The scattering of light in a medium is related to the polarizability of the medium in response to light. When light is treated as electromagnetic waves and the light polarization behavior is described in terms of electric field, electronic polarizability can be expressed by a polarizability tensor αᵢⱼ^{e}:

$${α}_{ij}^{e} = [ \begin{matrix}{α}_{11}^{e} & 0 & 0 \\ 0 & {α}_{22}^{e} & 0 \\ 0 & 0 & {α}_{33}^{e}\end{matrix} ] .$$

The polarizability tensor αᵢⱼ^{e} is related to the relative refractive index at the medium interface and can be alternatively expressed in a simpler form as ρ_{A} (light):

$${ρ}_{A} ( light ) = \frac{2 π n}{{λ}^{2}} \cdot \frac{d n}{d c} ,$$

where n is the relative refractive index at the medium interface, λ is the wavelength of light, and dn/dc is a change of refractive index (dn) in a unit volume (dc). When dn/dc≈0, the polarizability of the medium interface in response to light ρ_{A} (light)≈0 , which means a lowering of interference from the dicing tape 20 and which, therefore, allows a clear inspection image of the lower surface 13 of a scribing line 12 to be obtained.

According to the above, a clear inspection image can be obtained if the medium interface to be traversed in the optical path between the lower surface 13 and an inspection lens 31 is so adjusted that the refractive indices of the neighboring media are approximately the same to reduce polarized scattering by the dicing tape 20. To ensure the refractive indices of the neighboring media are approximately the same, the difference of refractive index between the first liquid medium 40 and the dicing tape 20 must not be greater than 0.3.

The step of inspecting the scribing lines (step S40) is performed as follows. A scribing line 12 is inspected by aiming the inspection lens 31 of an optical inspector 30 at the scribing line 12 through the transparent carrier 50 from below the lower surface 13. The inspection light received by the optical inspector 30 is visible light or infrared light.

With the dicing tape 20 having a refractive index n of about 1.544, the first liquid medium 40 may be water, whose refractive index n is about 1.333; glycerol, whose refractive index n is about 1.473; isopropyl alcohol, whose refractive index n is about 1.378; or ethanol, whose refractive index n is about 1.36. On the other hand, the transparent carrier 50 may be made of glass, whose refractive index n is about 1.52. As the refractive indices of the neighboring media are approximately the same, the optical path L″ along which the inspection light reflected by the dicing tape 20 travels through the first liquid medium 40 and the transparent carrier 50 is very close to the ideal image optical path L.

The small difference between the optical path L″ and the ideal image optical path L arises from the air medium 61 between the transparent carrier 50 and the inspection lens 31, wherein the refractive index n of the air medium 61 is about 1. The air medium 61 causes the optical path L″ of the inspection light to deflect slightly at the interface between the transparent carrier 50 and the air medium 61. Nevertheless, the difference between the ideal image optical path L and the optical path L″ is so small that the resolution of an image taken of the lower surface of a scribing line 12 by the inspection method S100 in this embodiment already exceeds that achievable by the conventional inspection methods.

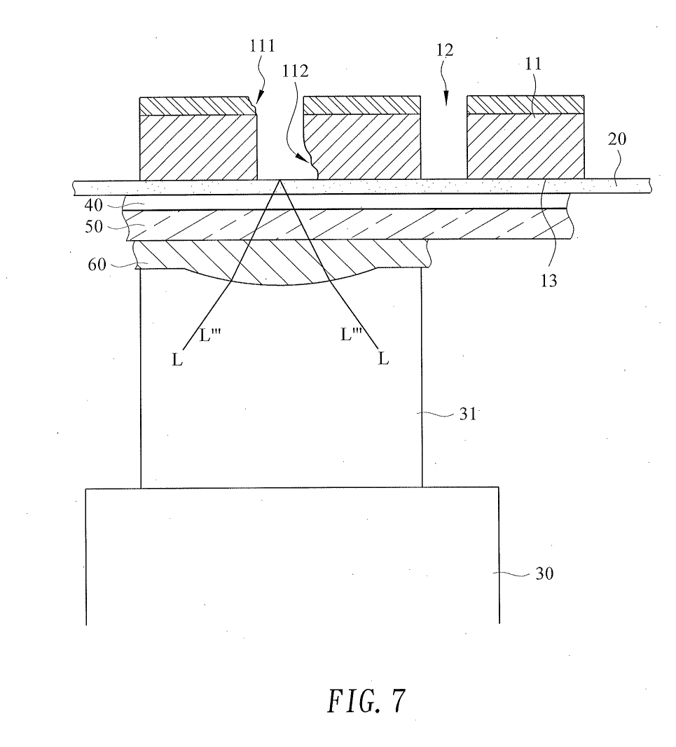

To better the previous embodiment, the inspection method S100 may further include the step of connecting with a second liquid medium (step S30) prior to step S40, as shown in FIG. 4 and FIG. 7. Step S30 is intended to further increase image resolution and involves applying a second liquid medium 60 in between the transparent carrier 50 and the inspection lens 31, wherein the second liquid medium may also be water, glycerol, isopropyl alcohol, or ethanol. The addition of the second liquid medium 60 helps correct the optical path deviation caused by the air medium 61 and, given the resulting uniformity in refractive index between the dicing tape 20, the first liquid medium 40, the transparent carrier 50, and the second liquid medium 60, allows the inspection light reflected by the lower-surface defect 112 to pass through the dicing tape 20, the first liquid medium 40, the transparent carrier 50, and the second liquid medium 60 without the directions of light energy distribution being changed by scattering. As a result, the light travels substantially along the ideal image optical path L (e.g., along the optical path L′″), and a sufficiently clear inspection image can be obtained with the optical inspector 30 as a basis on which to determine whether a scribing line 12 has lower-surface defects 112.

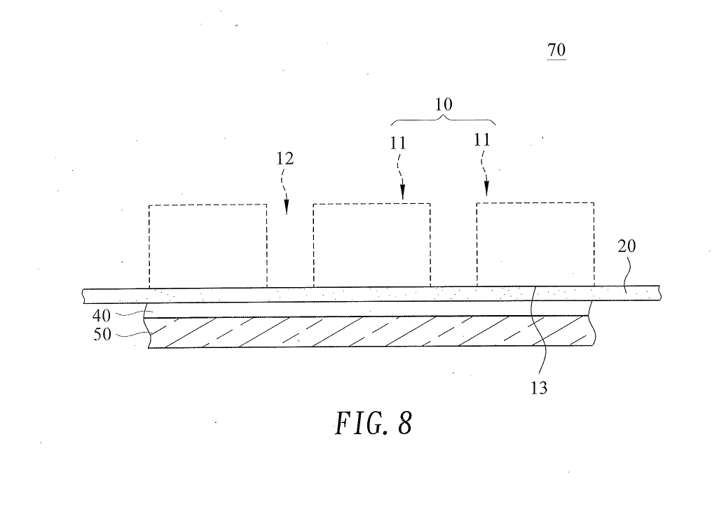

Referring to FIG. 8 for another embodiment of the present invention, an inspection fixture 70 for the scribing lines of a wafer includes a dicing tape 20 and a transparent carrier 50. Application of the inspection fixture 70 to the inspection of scribing lines 12 helps increase image resolution.

The dicing tape 20 is attached to a lower surface 13 of a to-be-inspected wafer 10, wherein the to-be-inspected wafer 10 has a plurality of dies 11 and a scribing line 12 formed between each two adjacent dies 11.

The transparent carrier 50 supports a first liquid medium 40. When placed on the transparent carrier 50, the dicing tape 20 is in seamless contact with the first liquid medium 40, thanks to the surface adhesion force of the first liquid medium 40 supported on the transparent carrier 50.

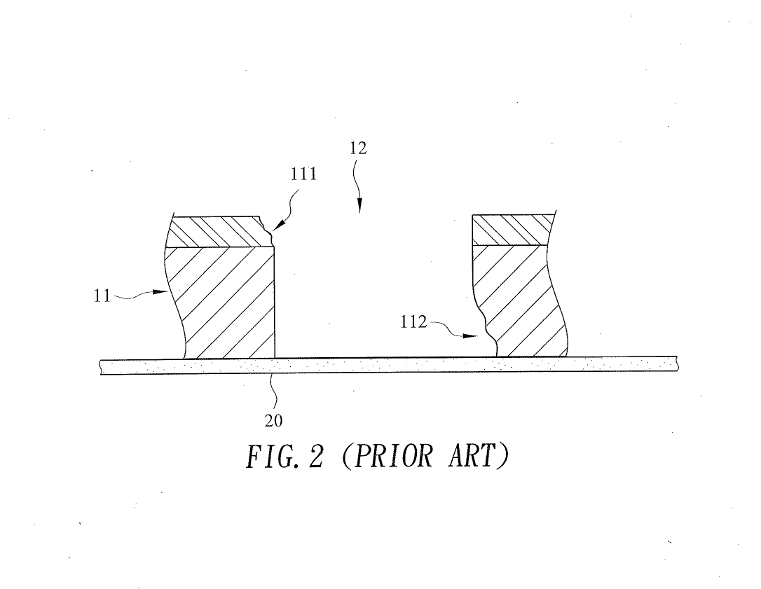

As stated previously, when the refractive indices of the media lying between the dicing tape 20 and an optical inspector are approximately the same, the inspection image is subject to relatively little interference from surface scattering of the dicing tape 20. Therefore, the difference of refractive index between the first liquid medium 40 and the dicing tape 20 must not be greater than 0.3. For example, the first liquid medium 40 may be water, glycerol, isopropyl alcohol, or ethanol while the transparent carrier 50 is made of glass, whose refractive index n is about 1.52 and is close to the refractive index of the dicing tape 20 (1.544). When materials meeting the aforesaid criterion are used, the inspection light reflected by the lower-surface defect 112 (shown in FIG. 2, FIG. 6, and FIG. 7) 20 will pass through the first liquid medium 40 and the transparent carrier 50 substantially along the ideal image optical path L, allowing a high-resolution and less-distortion inspection image to be obtained.

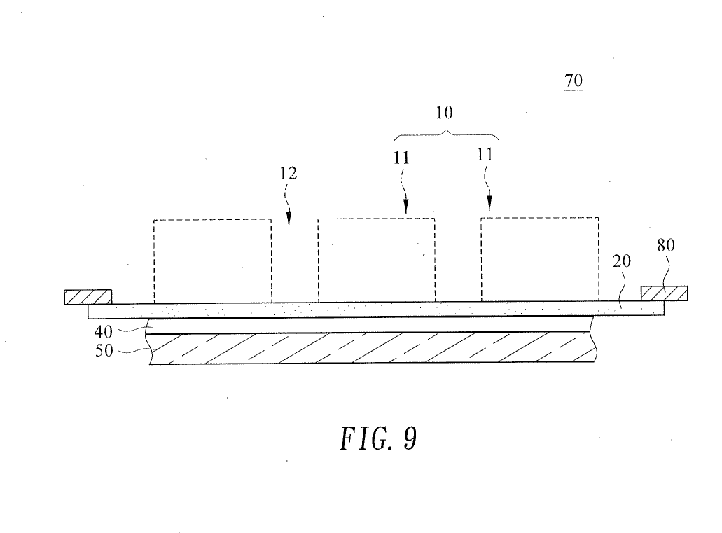

As shown in FIG. 9, the inspection fixture 70 may further include a clamping device 80 for clamping and thereby fixing two ends of the dicing tape 20. Now that the to-be-inspected wafer 10 is attached to the dicing tape 20, the clamping device 80 serves also to fix the to-be-inspected wafer 10 so that an optical inspector can inspect each scribing line 12. Moreover, with the clamping device 80 clamping the dicing tape 20, the to-be-inspected wafer 10 can be easily moved to facilitate subsequent tests or the remainder of the manufacturing process.

The features of the present invention are disclosed above by the preferred embodiment to allow persons skilled in the art to gain insight into the contents of the present invention and implement the present invention accordingly. The preferred embodiment of the present invention should not be interpreted as restrictive of the scope of the present invention. Hence, all equivalent modifications or amendments made to the aforesaid embodiment should fall within the scope of the appended claims.

What is claimed is:

1. An inspection method for scribing lines of a wafer, comprising the steps of:
providing a to-be-inspected wafer, wherein the to-be-inspected wafer has a plurality of dies, a scribing line formed between each two adjacent said dies, and a lower surface attached with a dicing tape;
connecting the dicing tape with a transparent carrier supporting a first liquid medium, wherein the dicing tape is placed on the transparent carrier and is contacted seamlessly with the first liquid medium, and a difference of refractive index between the first liquid medium and the dicing tape is less than 0.3; and
inspecting the scribing lines, wherein an inspection lens of an optical inspector is aimed at each said scribing line through the transparent carrier from below the lower surface to inspect the scribing lines.

2. The inspection method of claim 1, wherein the first liquid medium is water, glycerol, isopropyl alcohol, or ethanol.

3. The inspection method of claim 1, wherein an air medium exists between the transparent carrier and the inspection lens.

4. The inspection method of claim 1, further comprising the step of: connecting the transparent carrier and the inspection lens with a second liquid medium, wherein the second liquid medium is applied in between the transparent carrier and the inspection lens.

5. The inspection method of claim 4, wherein the second liquid medium is water, glycerol, isopropyl alcohol, or ethanol.

6. The inspection method of claim 1, wherein the transparent carrier is made of glass.

7. The inspection method of claim 1, wherein the optical inspector receives an inspection light, and the inspection light is visible light or infrared light.

8. An inspection fixture for scribing lines of a wafer, comprising:
a dicing tape attached to a lower surface of a to-be-inspected wafer; and
a transparent carrier for supporting a first liquid medium and allowing the first liquid medium to contact seamlessly with the dicing tape, wherein a difference of refractive index between the first liquid medium and the dicing tape is less than 0.3.

9. The inspection fixture of claim 8, further comprising a clamping device for clamping and thereby fixing two ends of the dicing tape.

10. The inspection fixture of claim 8, wherein the first liquid medium is water, glycerol, isopropyl alcohol, or ethanol.

11. The inspection fixture of claim 8, wherein the transparent carrier is made of glass.
